(19) United States
(12) Patent Application Publication
(10) Pub. No.: US 2004/0194256 A1
(43) Pub. Date: Oct. 7, 2004

(54) Two-sided pop up structure for notebook/tablet PC

(76) Inventors: Wen-Hsiang Chen, Taipei Hsien (TW); Kuo-Chang Yang, Hsinchu (TW); Chung-Yu Lee, Taipei Hsien (TW)

Correspondence Address: RABIN & BERDO, P.C., Suite 500, 1101 14 Street, N.W., Washington, DC, 20005, US

(21) Appl. No.: 10/702,516

(22) Filed: Nov. 7, 2003

(30) Foreign Application Priority Data
Apr. 3, 2003 (TW) 92205270

(51) Int. Cl. E05D 1/00

(52) U.S. Cl. 16/366

(57) ABSTRACT

A two-sided POP UP structure is employed to pop up a LCD screen of notebook/tablet PC while releasing. A display panel of a notebook/tablet PC is connected to a mainframe of the notebook/tablet PC via a hinge. The two-sided POP UP structure has a male part and female part. One end of the male part is fixed to the hinge, and the other end is a cylinder with a holding rib. One end of the female part is fixed to the display panel, and the other end is an elastic metal shaped around the cylinder of the male part. The elastic metal is cut to form a rotation slot for the holding rib. When the holding rib interferes with the elastic metal, the elastic metal deforms to allow the LCD screen to pop up more easily.

### BACKGROUND OF THE INVENTION

1. Field of Invention

The present invention relates to a two-sided pop up structure. More particularly, the present invention relates to a two-sided pop up structure for a notebook/tablet PC.

2. Description of Related Art

Notebook computers have become quite popular in market in recent years because of their lowering price and improving performance. A Tablet PC has all of the original advantages of the notebook PC, such as powerful computing performance and large display and is further equipped with a manual input function. Therefore, users can use the Tablet PC in more places.

A rotatable and convertible hinge for the Notebook/Tablet PC has been developed for the user's convenience. The LCD screen can be swiveled and folded back on two sides. However, there are inconveniences while opening or closing the LCD screen. Occasionally, the LCD screen may fold back and reclamp after unlocking the LCD screen.

### SUMMARY OF THE INVENTION

It is therefore an objective of the present invention to provide a two-sided POP UP structure for lifting the LCD screen with ease while releasing the same from a mainframe thereof.

In accordance with the foregoing and other objectives of the present invention, a two-sided POP UP structure is employed to pop up a LCD screen of notebook/tablet PC during release. A display panel of a notebook/tablet PC is connected to a mainframe of the notebook/tablet PC via a hinge. The two-sided POP UP structure includes a male part and female part. One end of the male part is fixed to the hinge, and the other end is a cylinder with a holding rib. One end of the female part is fixed to the display panel, and the other end is an elastic metal shaped around the cylinder of the male part. The elastic metal is cut to form a rotation slot for the holding rib. When the holding rib interferes with the elastic metal, the elastic metal deforms to allow popping up the LCD screen with greater ease.

In accordance with one preferred embodiment of present invention, the holding rib of the cylinder is circular pin or square block. A predetermined gap is left between two ends of the elastic metals while being shaped around the cylinder of the male part. Moreover, the male part is fixed to the hinge by bolt fastening. The female part is fixed to the LCD screen by bolt fastening.

It is to be understood that both the foregoing general description and the following detailed description are examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a perspective view of a notebook/tablet PC according to one preferred embodiment of present invention;

FIG. 2A illustrates a cross-sectional view of a notebook/tablet PC according to one preferred embodiment of this invention;

FIG. 2B illustrates a enlarged detailed view of a notebook/tablet PC's hinge according to one preferred embodiment of this invention;

FIG. 3A illustrates a perspective view of a two-sided pop up structure according to one preferred embodiment of this invention;

FIG. 3B illustrates a perspective view of a two-sided pop up structure's female part according to one preferred embodiment of this invention;

FIG. 4A illustrates a bottom view of a two-sided pop up structure's female part according to one preferred embodiment of this invention; and

FIG. 4B illustrates a cross-sectional view of a two-sided pop up structure's female part according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The two-sided pop up structure of present invention redesigns a hinge structure of a notebook/tablet PC. In one preferred embodiment of present invention, the hinge structure has two sub-hinges. The first sub-hinge is employed to swivel a LCD screen of the notebook/tablet PC. The second sub-hinge is employed to fold straight or to fold back the LCD screen. The two-sided pop up structure of present invention is included in the second sub-hinge.

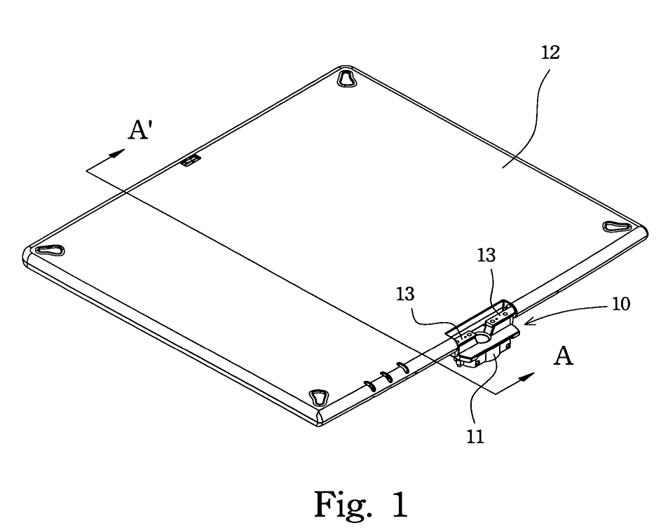

FIG. 1 illustrates a perspective view of a notebook/tablet PC according to one preferred embodiment of present invention. The hinge 10 functions to link a LCD 10 to a mainframe. The hinge 10 includes a first sub-hinge 11 and two second sub-hinges 13. As mentioned above, the first sub-hinge 11 is employed to swivel a LCD screen of the notebook/tablet PC while two second sub-hinges 13 are employed to fold straight or to fold back the LCD screen. The two-sided pop up structure of present invention is one of two second sub-hinges 13.

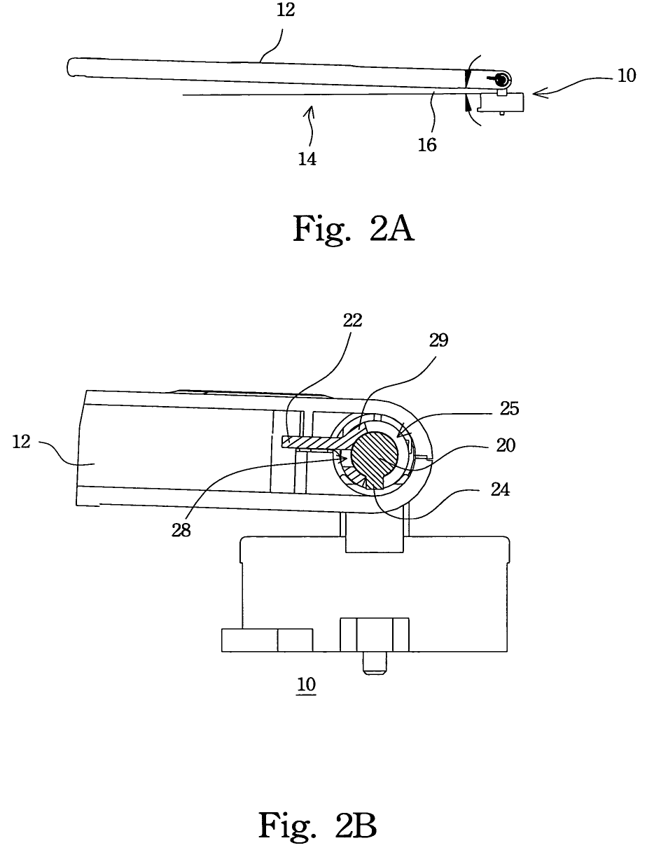

FIG. 2A illustrates a cross-sectional view of a notebook/tablet PC along a cross-section line A-A′ in FIG. 1, according to one preferred embodiment of this invention. When the LCD screen 12 is folded back to its mainframe, an angle 16 between the screen and the mainframe is predetermined, such as 2 degrees. The pop up structure of a hinge 10 begins to save energy for popping up the screen when the angle 16 is less than the predetermined angle, such as 2 degrees.

FIG. 2B illustrates an enlarged detailed view of a notebook/tablet PC's hinge in FIG. 2A according to one preferred embodiment of this invention. A two-sided pop up structure is a kind of hinge for folding straight or folding back the LCD screen. The two-sided pop up structure includes a male part 20 and a female part 22. One end of the male part 20 is fixed to hinge 10 and the other end of the male part 20 is connected to the female part 22. The male part 20 further includes a holding rib 24. The holding rib 24 can be a circular pin or square block. One end of the female part 22 is fixed to an LCD screen 12 of a notebook/tablet PC. The other end of the female part 22 is an elastic metal 29 shaped around one end of the male part 20. A gap 28 is left between two ends of the elastic metal 29. The elastic metal 29 is cut to form a rotation slot 25 10 allowing the holding rib 24 to move within. The elastic metal 29 allows the LCD screen 12 to pop up more easily because the elastic metal 29 interferes with the holding rib 24 when the holding rib 24 moves to two ends of the rotation slot 25.

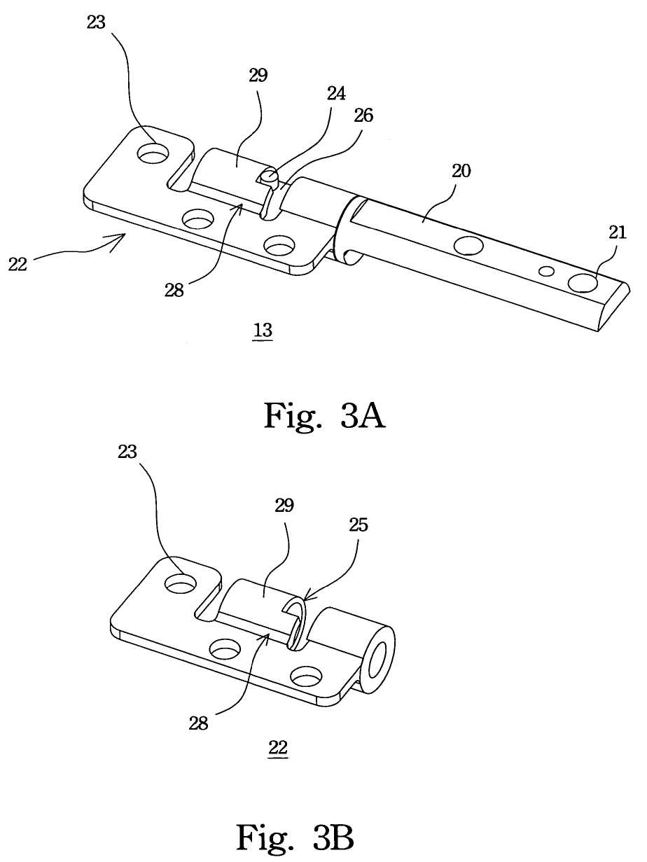

FIG. 3A illustrates a perspective view of a two-sided pop up structure according to one preferred embodiment of this invention. As mentioned above, the two-sided pop up structure in FIG. 3A is the second sub-hinge 13 in FIG. 1. The two-sided pop up structure includes a male part 20 and a female part 22. One end of the male part 20 is fixed to the first sub-hinge 11 (illustrated in FIG. 1) by bolt fastening via screw hole 21. The other end of the male part 20 is a cylinder 26 connected to the female part 22. The male part 22 further includes a holding rib 24 on the cylinder 26. The holding rib 24 can be a circular pin (as illustrated in FIG. 3A) or a square block. One end of the female part 22 is fixed to the LCD screen of the notebook/tablet PC by bolt fastening via screw hole 23. The other end of the female part 22 connecting to the male part 20 is an elastic metal 29.

FIG. 3B illustrates a perspective view of a two-sided pop up structure's female part 22 in FIG. 3A according to one preferred embodiment of this invention. Referring to both FIG. 3A and FIG. 3B, the elastic metal 29 is shaped around a cylinder 26 of the male part 20. A predetermined gap 28 is left between two ends of the elastic metal 29. The elastic metal 29 is cut to form a rotation slot 25 allowing the holding rib 24 to move within. The holding rib 24 interferes with the elastic metal 29 while moving to two ends of the rotation slot 25. Owing to the predetermined gap 28 left within the elastic metal 29, the elastic metal 29 can deform and allow the LCD screen to pop up more easily while interfering with the holding rib 24.

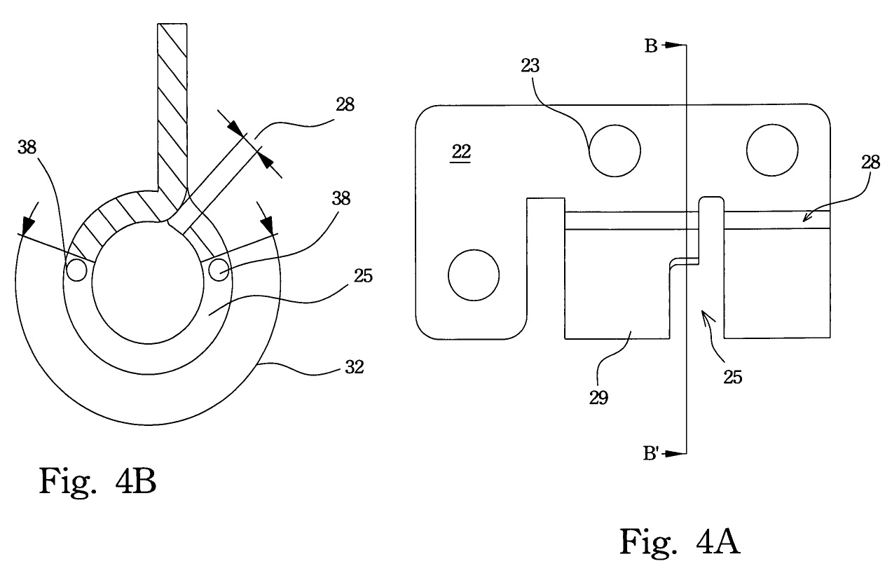

FIG. 4A illustrates a bottom view of a two-sided pop up structure's female part in FIG. 4A according to one preferred embodiment of this invention. FIG. 4B illustrates a cross-sectional view of a two-sided pop up structure's female part along cross-section line B-B′ in FIG. 4A according to one preferred embodiment of this invention. Referring to FIG. 4A and FIG. 4B, the rotation slot 25 allows the holding rib 24 to move within. The dimension 32 of rotation slot 25 can be adjusted according to the demand, such as the desired pop up angle. A predetermined gap 28 is left as a space for the elastic metal's deformation. When the holding rib 24 moves to the two ends 38 of the rotation slot 25, the angle between the LCD screen and its mainframe is the pop up angle. When the LCD screen is folded back and clamped to its mainframe, the elastic metal deforms due to interference between the holding rib and the elastic metal. Thus, the elastic metal can allow the LCD screen to pop up more easily while unlocking the LCD screen.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A two-sided pop up structure employed to pop up a LCD screen of a notebook/tablet PC, said LCD screen being connected to a mainframe of said notebook/tablet PC by a hinge including said two-sided pop up structure, said two-sided pop up structure comprising:
a male part, one end of said male part being connected to said hinge, another end of said male part being a cylinder;
a holding rib, located on said cylinder; and
a female part, one end of said female part fixed to said LCD screen, another end of said female part being an elastic metal shaped around said cylinder, said elastic metal being cut to form a rotation slot for said holding rib, wherein said elastic metal allows said LCD screen to pop up more easily because said elastic metal interferes with said holding rib while said holding rib moves to two ends of said rotation slot.

2. The two-sided pop up structure of claim 1, wherein said holding rib is circular pin or square block.

3. The two-sided pop up structure of claim 1, wherein a predetermined gap is left between two ends of said elastic metals while being shaped around said cylinder.

4. The two-sided pop up structure of claim 1, wherein said male part is fixed to said hinge by bolt fastening.

5. The two-sided pop up structure of claim 1, wherein said female part is fixed to said LCD screen by bolt fastening.

6. A two-sided pop up hinge employed to link a LCD screen and a mainframe of a notebook/tablet PC, said two-sided pop up hinge comprising:
a first hinge, employed to swivel said LCD screen of said notebook/tablet PC, said first hinge having a second rotation part and a first rotation part fixed to said mainframe; and
a second hinge comprising:
a male part, one end of said male part connected to said second rotation part, another end of said male part being a cylinder;
a holding rib, located on said cylinder; and
a female part, one end of said female part fixed to said LCD screen, is another end of said female part being an elastic metal shaped around said cylinder, said elastic metal being cut to form a rotation slot for said holding rib, wherein said elastic metal allows said LCD screen to open more easily because said elastic metal interferes with said holding rib while said holding rib moves to two ends of said rotation slot.

7. The two-sided pop up hinge of claim 6, wherein said holding rib is circular pin or square block.

8. The two-sided pop up hinge of claim 6, wherein a predetermined gap is left between two ends of said elastic metals while being shaped around said cylinder.

9. The two-sided pop up hinge of claim 6, wherein said male part is fixed to said hinge by bolt fastening.

10. The two-sided pop up hinge of claim 6, wherein said female part is fixed to said LCD screen by bolt fastening.
